(19) United States
(12) Patent Application Publication
(10) Pub. No.: US 2006/0112281 A1
(43) Pub. Date: May 25, 2006

(54) Anti virus device

(76) Inventor: Waldir Jose Nobre, Florianopolis/SC (BR)

Correspondence Address: Martin P. Endres, Esq.;HEDMAN & COSTIGAN, P.C., 1185 Avenue of the Americas, New York, NY, 10036, US

(21) Appl. No.: 10/976,707

(22) Filed: Oct. 29, 2004

(51) Int. Cl. H04L 9/32

(52) U.S. Cl. 713/188

(57) ABSTRACT

Anti virus device is an electric mechanical circuitry to protect the hard disks of computers from virus, hooked up to the hard disk, with electric mechanical selection for the hard disk protected area, externally performed by the user, with totally isolated operation from the programs processed by the computer, with independent functionality from the virus nature or newness and immune itself from the virus attack, based on the functionality allowed by the creation of reserved areas at the hard disk, with local and size strictly determined; the first step being the demarcation of the hard disk areas where each area will be protected by a electrical breaker (part of the device) connected to the control unit through a logical port (AND, NAND or any other) and this logic enabling or disabling writing at the magnetic media of the hard disk according to the user needs, by the electrical breaker position.

### FIELD OF THE INVENTION

The present invention relates to a method and apparatus for protecting the operational system, application software's and files installed at the hard disk of computers from viruses, which access these computers via Internet, disks and diskettes.

### BACKGROUND OF THE INVENTION

Anti-virus software's are well known and broadly used. These programs monitor the files being received by the computer and in case the same files are executable the anti-virus program blocks or warns the user about the virus.

The protection offered by these software's is important but does not eliminate the chain: new virus, new software, new virus, new software. In other words the complete protection normally occurs after some damage had already been caused by the new virus. And the damages happen in the files of either the operational system or of the application software's, all installed at the hard disk.

### SUMMARY OF THE INVENTION

The objective of this invention is to correct this failure of the current anti-virus security systems. A device is designed in other to not allow the viruses damage or erase files from the user computer. It is intended to reach this objective through a physical protection, similar to the one used in the diskettes where a mechanical key enables the write mode.

The device, object of this requirement, comprises a hardware related method and an apparatus installed at the hard disk. It is known that the space in the hard disk can be divided into areas, and these areas can be reserved to install the operational system and the application software. The anti-virus device does not allow recording or writing at the selected areas through an electrical (physical) interruption which works independently from any program being processed.

This patent requirement is based on the functionality allowed by the creation of reserved areas at the hard disk, with local and size strictly determined. So the first step is the demarcation of the hard disk areas. Then the contents to be protected are recorded in the reserved areas. Finally the protection device is actuated by the user and only reading will be allowed from the reserved areas. If a new virus tries to access the computer, it will not succeed on writing, change or erase the content of the protected areas.

### BRIEF DESCRIPTION OF THE DRAWINGS

FIG. 1 is a representation of the hard disk divided in 5 logical areas, A, B, C, D and E

FIG. 2 illustrates the anti virus device (EE) into dot lines connected to the hard disk control unit (BB).

FIG. 3 represents the way to build the logical circuit for each breaker.

### DESCRIPTION OF THE DRAWINGS

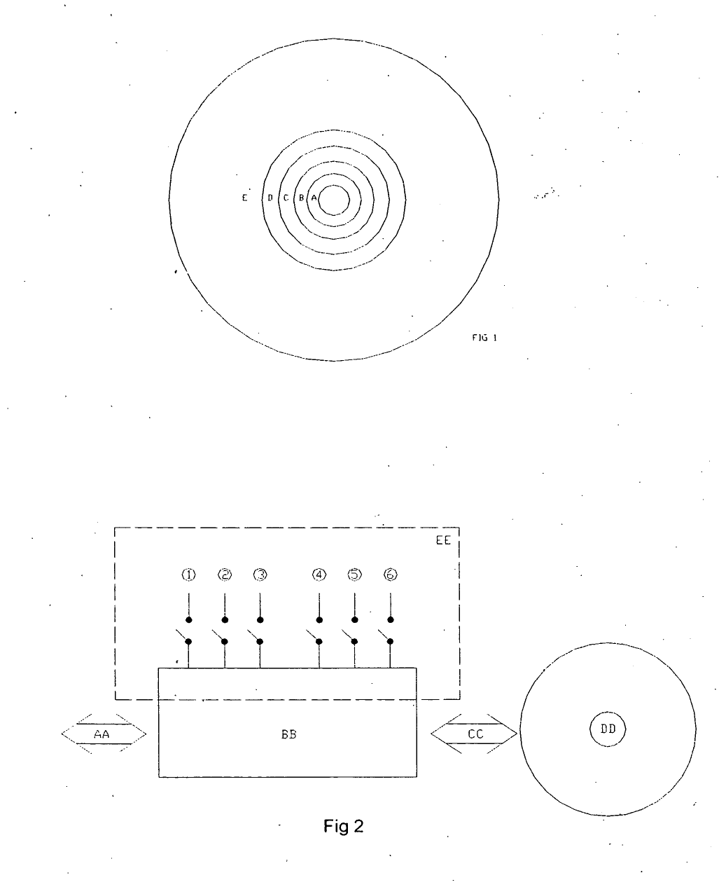

FIG. 1 is a representation of the hard disk divided in 5 logical areas, A, B, C, D and E. As an example one could consider the areas A, B, C and D with 1 GB storage capacity and area E with the rest of the capacity. The protection device can select which areas are protected and change this selection according to the user needs. For instance, in order to write at area A the electrical breaker (part of the device) shall be set at the correspondent position, and after the writing the position is set back.

The operational system could be stored in area A. The system temporary files could use area B. The selected files could be saved at area C. And so on. The sizes of reserved areas can be adjusted through selection of the anti-virus device keys, allowing user configuration.

FIG. 2 illustrates the apparatus into dot lines (EE) connected to the hard disk control unit (BB), as per the example above. There are five electrical breakers (01 to 05), one per each configured hard disk area, connected to the control unit (BB) through a logical port (AND, NAND or any other) in a way that:

01—Electrical switch that enables writing into area A, through a logical port

02—Electrical switch that enables writing into area B, through a logical port

03—Electrical switch that enables writing into area C, through a logical port

04—Electrical switch that enables writing into area D, through a logical port

05—Electrical switch that enables writing into area E, through a logical port

This logic enables or disables the read/write head (CC) from writing at the magnetic media (DD) of the hard disk control unit (BB). The hard disk control unit (BB) receives the commands and digital data from the computer data bus (AA) and transforms them into electrical signals to be recorded at the media.

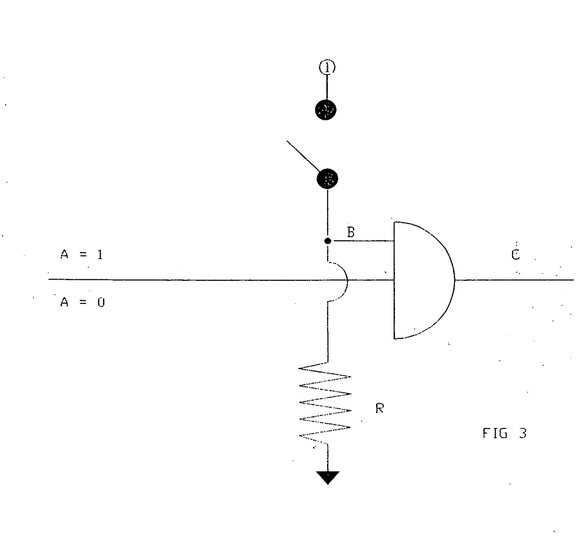

FIG. 3 represents the way to build the logical circuit for each breaker. This circuit enables the possibility of only reading, or reading and writing modes, according to the breaker (B) position. Each breaker (B) protects its specific area and its functionality is independent of the others.

The illustrated logical port is an OR. When the breaker (B) is open signal is 0 (zero). The signal (A) is 1 (one) for the only reading mode (R) and it is 0 (zero) for writing mode (W).

| A | B | C |
|---|---|---|
| SIGNAL | OPEN BREAKER | COMMAND |
| 1 (R) | 0 | 1 (R) |
| 0 (W) | 0 | 0 (W) |

In this case the signal (C) is equal to the input A and the hard disk can execute any command from the computer.
When the breaker (B) is closed, signal is 1 (one).

Again input signal (A) is 1 (one) for the only reading mode (R) and it is 0 (zero) for writing mode (W).

| A | B | C |
|---|---|---|
| SIGNAL | CLOSED BREAKER | COMMAND |
| 1 (R) | 1 | 1 (R) |
| 0 (W) | 1 | 1 (R) |

The signal (C) is always 1 (one), independently from the input A, and does not allow the writing mode, only enabling the reading mode.

Finally it is important to bring out that the main difference between the anti-virus device, object of this patent requirement, and other already known in the market, is the hardware related method of protection. The content of protected areas can only suffer alterations through physical (mechanical) permission. Therefore no software instruction could alter these protected contents.

1. A method of protecting the hard disks of computers against viruses using only hardware (physical) apparatus.

2. The method of claim 1, wherein the device works independently from the installed software or new coming programs, the latter with or without viruses, which will not contaminate the protected areas.

3. The method of claim 1, wherein the hard disc is physically, electromechanically, protected from viruses.

4. The method of claim 3, wherein the user can select areas of the hard disc to be protected, each area will be protected by a electrical breaker (part of the device) connected to the control unit through a logical port (AND, NAND or any other). This logic enables or disables writing at the magnetic media of the hard disk according to the user needs, by the electrical breaker position.

5. An apparatus designed under the method of claim 1 in order to protect the computer hard disc from virus.

6. The apparatus of claim 5, wherein the circuit is connected to the hard disk control unit.

7. The apparatus of claim 5, wherein the computer user can physically (electromechanically) select the areas to be protected at the hard disk.
